(19) United States
(12) Patent Application Publication
(10) Pub. No.: US 2026/0282175 A1
(43) Pub. Date: Sep. 17, 2026

(54) Inductively heating an object involving an optical temperature sensor

(71) Applicant: PHOTONFIRST IP B.V., Alkmaar (NL)

(72) Inventors: Gideon LANGEDIJK, Alkmaar (NL); Ewoud Verius VELU, Alkmaar (NL)

(21) Appl. No.: 19/565,080

(22) Filed: Mar. 12, 2026

(30) Foreign Application Priority Data
Mar. 13, 2025 (NL) 4000019

(51) Int. Cl. H05B 6/06; H05B 1/02; H05B 6/36

(52) U.S. Cl. CPC H05B 6/06; H05B 1/023; H05B 6/36

(57) ABSTRACT

A system and a method for inductive heating of an object are presented. The system comprises an inductive heating coil and an electronic controller adapted to provide electrical power to the inductive heating coil. At least one optical waveguide is positioned in between the inductive heating coil and the object. The optical waveguide(s) comprises at least one optical temperature sensor arranged to obtain measurement signals by means of light. The system further comprises an optical measurement subsystem adapted to receive the measurement signals from the optical temperature sensor(s). The optical measurement subsystem is further adapted to determine a at least one local temperature of the object based on the measurement signals. The optical measurement subsystem is adapted to provide a feedback signal to the electronic controller based on the plurality of local temperatures.

### RELATED APPLICATION

The present application claims priority to and the benefit of Netherlands Application No. 4000019, filed on Mar. 13, 2025. The disclosure of which is incorporated herein by reference in its entirety.

### FIELD OF THE INVENTION

The present disclosure relates to inductive heating systems and methods. More specifically, the present disclosure relates to a system and a method of inductively heating an object in an industrial setting, involving an optical temperature sensor.

### BACKGROUND OF THE INVENTION

Inductive heating is a process of heating an object without contacting the object and without requiring an external heat source. The heat is generated in the object itself by electrical energy transfer without electrical connection and as a result the object can be heated fast. Such heating process can be beneficial in large scale, high throughput processes, wherein objects are heated, e.g., for welding, soldering, tempering, and etcetera.

In an industrial setting, an inductive heating process may include a controller providing a high frequency alternating current (AC) through an inductive heating head acting as a spool. Conductive material of an object in the proximity of the inductive heating head may pick up the generated magnetic fields, thereby creating eddy currents in said object, which in turn creates heat by resistive heating of the obtained currents. The controller may adjust the power transfer by adjusting a parameter of the AC current, such as the frequency, amplitude, phase angle, or duty cycle.

In order to correctly adjust the frequency of the AC current, the controller may obtain some information about the temperature of the object. Since inductive heating is a contact-less process, contact-based temperature sensors, such as thermocouples, thermistors, resistance temperature detector (RTDs) or semiconductor-based sensors, cannot be used to determine the temperature of the object. This is due to the fact that the strong inductive electric fields create unwanted eddy currents in conductive sensors. Instead, temperature sensors that can be placed at some distance of the object are typically used.

Contact-less or distant temperature sensors, such as pyrometers, infrared sensors, or the like are known in conjunction with inductive heating systems. Disadvantageously, these known contact-less temperature sensors need to be calibrated and positioned precisely to obtain correct temperature measurements of the heated object. It has been found that such calibration and positioning is often performed sub-optimally, resulting in less accurate temperature readings. This in turn can result in a sub-optimal control of the inductive heating process.

### SUMMARY OF THE INVENTION

The present disclosure aims to provide an improved inductive heating system and method, wherein a more realistic feedback signal of the heating situation can be obtained. The improved inductive heating system allows for accurate temperature readings during the inductive heating process of an object, enabling accurate adjustment of the process temperature during the heating process.

According to an aspect of the present disclosure, a system for inductive heating of an object is presented. The system may include an inductive heating coil. The system may further include an electronic controller adapted to provide electrical power to the inductive heating coil. At least one optical waveguide may be positioned adjacent to, preferably in between, the inductive heating coil and the object. Each optical waveguide may include at least one optical temperature sensor. The at least one optical temperature sensor may be arranged to obtain measurement signals by means of light. The system may include an optical measurement subsystem. The optical measurement subsystem may be adapted to receive the measurement signals from the at least one optical temperature sensor of the at least one optical waveguide. The optical measurement subsystem may further be adapted to determine at least one local temperature of the object based on the measurement signals. The optical measurement subsystem may be adapted to provide a feedback signal to the electronic controller based on the plurality of local temperatures.

The wording “electrical power” is to be understood as the amount of current being passed through the inductive heating coil for a given time step. Over a finite amount of time, there is thus a total amount of energy transferred to the object based on a multiplication of the electrical power with the time duration. The electrical power may fluctuate in the time due to instructions from the controller, wherein the amount of change per time division can be understood as the rate or the derivative of the electrical power.

Furthermore a practical challenge to the inductive heating process is that electrically based (by measuring the voltage/current/resistance of the heating coil) control loops inevitable deviate from the true heating process, because some electricity is leaked away to ground or internal eddy currents are formed in the electronics. The advantage of the current method according to the disclosure is that only the correctly transferred energy that is utilized to generate heat in the object is identified (object's temperature is measured) to provide feedback for the system.

Advantageously, the system for inductive heating of the present disclosure enables higher accuracy compared to known inductive heating systems. The optical waveguide, which is preferably implemented by an optical fiber, is not heated by induction because it is not electrically conductive. Since the optical fiber is not affected (heated-up), a true temperature measurement of the object can be obtained. This temperature measurement may subsequently be utilized to provide feedback to the electronic controller of the system to allow adjustments to the induction parameters to be made. Thus, induction parameters may be finely tuned based on the requirements of the object's temperature. Non-limiting examples of induction parameters are an amount of time of heating, a position of the object relative to the inductive heating coil and having a differently heating coil or object.

Another advantage achieved by the system of the present disclosure is that the actual temperature of the object can be measured accurately when performing inductive heating on the object, something which is typically not possible in known systems. In known systems, typically the temperature of the heating coil is measured instead of the object being heated, which is then used as an indicator of the object's temperature. Disadvantageously, there can be many factors that cause the temperature of the heating coil to be different from the object that is being heated, such as the distance between the heating coil and the object. Measuring the temperature of the heating coil to provide feedback to the inductive heating system, such as is typically done in known systems, typically leads to inaccuracies and problems in low-tolerance processes. The system for inductive heating of the present disclosure advantageously measures at least one temperature of the object using one or more optical temperature sensors, resulting in the provided feedback signal to be a better representation of the true temperature of the object compared to the feedback signal in known systems. Thus, the system for inductive heating of the present disclosure enables operation of the system with higher accuracy and lower tolerances.

Yet another advantage is that the system can utilize and work with materials having lower quality (and thus larger material property differences) even in continuous, high throughput, or assembly line processes, because the true temperature of the objects are being measured and used as feedback for the system. This makes the system flexible and adaptive.

In an embodiment, the electronic controller may be adapted to adjust the provided electrical power to the inductive heating coil based on the feedback signal.

It can be beneficial to adjust the electrical power provided to the inductive heating coil by the electronic controller, since this would immediately affect the amount of energy transfer to or absorption in the object, thereby directly affecting its temperature. It should be noted that this embodiment not only pertains to the adjustment of the temporal peak or total amount of energy provided to the object, but also relates to the timespan over which the electrical power may be provided. For example, it may be beneficial to decrease the provided electrical power, based on the feedback signal, but at a slow rate because the object itself may be losing a lot of energy due to radiation. A drop in provided electrical power would then decrease the temperature of the object in a greater amount than a drop in provided electrical power of equal amount of an object which is losing/radiating less energy.

In an embodiment, the system may include moving means configured to move the inductive heating coil. The moving means may be adapted to adjust the position of the inductive heating coil relative to the object to be heated based on the feedback signal.

The electronic controller may be adapted to instruct the moving means to change a relative distance between the inductive heating coil and the object by moving the inductive heating coil or by moving the object. The instruction(s) from the electronic controller to the moving means are typically based on the feedback signal.

It can be beneficial to adjust the relative distance between the inductive heating coil and the object. Such adjustment may be performed, e.g., by moving the inductive heating coil or by moving the object. A greater distance may cause less electrical power to be transferred from the inductive heating coil to the object, and oppositely, a shorter distance may lead to larger inductive power to be transfer to the object. Advantageously, the transferred inductive power may be adjusted effectively and easily by changing the relative distance between the object and the heating coil.

The inductive heating coil may be moved at the same time as adjusting the electrical power provided to the inductive heating coil.

Advantageously, changing the relative distance between the object and the inductive heating coil may overcome misalignments of the inductive heating coil with respect to the object, wherein, e.g., one side of the object is heated more than the other side. By changing the relative position of the object with respect to the inductive heating coil, a different heat distribution may be obtained on the object. This may result in a more even heating of the object, or, in another example, may be used to achieve heating of only one side of object.

In an embodiment, the optical measurement subsystem may be adapted to use the feedback signal proportionally, preferably as a P control loop.

In an embodiment, the optical measurement subsystem may be adapted to use the feedback signal both proportionally and integratively, preferably as a PI control loop.

In an embodiment, the optical measurement subsystem may be adapted to use the feedback signal both proportionally and derivatively, preferably as a PD control loop.

In an embodiment, the optical measurement subsystem may be adapted to use the feedback signal both proportionally integratively and derivatively, preferably as a PID control loop.

In an embodiment, the optical measurement subsystem may be adapted to use the feedback signal by second order.

The above embodiments of feedback signal usages relate to different implementations of a control loop with respect to the strength of the feedback signal as a function of time. In its simplest form, a proportional control loop may be utilized, wherein the strength of the feedback signal is directly and proportionally used for providing electrical power or for determining the distance between object and coil.

The feedback signal may be determined based on a value of the measured temperature of the object, but preferably on a value of the difference between an intended temperature and the measured temperature. Such value may, in the proportional case, be multiplied with a proportionality factor to obtain a required electrical power to be provided and/or a required distance to be displaced.

The derivative of the feedback signal may be used, or the history of said feedback signal, e.g., by taking the integral of the signal, to obtain the required electrical power and/or distance.

Higher order control loops may be used, wherein not only the temperature (or temperature difference) and a gradient, but also the second derivative may be used to determine the feedback signal.

In an embodiment, the at least one optical waveguide may include at least two optical temperature sensors, such that at least two local temperatures of the object are determinable.

In an embodiment, the at least one optical waveguide may include at least two optical waveguides, such that least two local temperatures of the object are determinable.

Two or more optical temperature sensors may be present in the system, e.g., provided in one optical waveguide or provided in multiple optical waveguides each comprising one or more optical temperature sensor.

Advantageously, a plurality of local temperatures may be measured of the object, allowing to obtain a better temperature representation of the object or allowing to obtain spatial information of the temperature of the object. For example, in case two optical temperature sensors are utilized and provided on different sides of the object to be heated, when one sensor measures a higher temperature, it may be concluded that the inductive heating coil is misaligned with respect to the object. Such misalignment possibly results in one side of the object becoming hotter than the other side of the object, and the electronic controller may perform the required adjustments accordingly. The thus obtained feedback signals allow the system to not only achieve higher accuracy in heating an object inductively, but also allows to provide the desired heat distribution on/in the object.

In an embodiment, the optical measurement subsystem may be arranged to determine the feedback signal based on mathematical operations on the at least two local temperatures. The mathematical operations may include one or more of: an arithmetic mean; a minimum; a maximum; and a weighted average.

Dependent on the actual implementation of the system, one mathematical implementation may be more beneficial than another. For example, utilizing the mean of the local temperatures may indicate a more correct temperature of the object to be heated, whereas the use of the maximum local temperature may provide a feedback signal which would reduce the chance of overheating the object.

In an embodiment, the optical measurement subsystem may be arranged to compare the plurality of local temperatures to a spatial model of the object to determine the feedback signal.

A plurality of optical temperature sensors provided in the system surrounding the object may provide local temperatures of the object at different locations. When combined with a spatial model of the object, the measured temperatures can be mapped more closely to the desired temperature at a given position or to a temperature distribution of the object. For example, a three-dimensional object may require a certain core temperature for the inductive heating process. Since the core temperature cannot directly be measured, but the local temperatures of the surface of the object can be measured, they can be compared to a three-dimensional heat model of said object. With this implementation, lower tolerances in the heating may advantageously be achieved.

In an embodiment, the at least one optical temperature sensor of the system may include a Fiber Bragg Grating (FBG), a Fabry-Pérot etalon (FPE), a Distributed Bragg Reflector (DBR), a Photonic Bandgap Structure, a Photonic Crystal, Reflective Coating, and/or a Grating Structure.

Depending on the requirements of the system, a different implementation of the optical temperature sensor may be chosen. In a preferred embodiment, the optical temperature sensor includes an FBG because of its ease of manufacturing. The mentioned implementations of optical temperature sensors allow great tunability with respect to a reflective spectral range and are therefore tunable with respect to a specific temperature range for the object to be heated inductively.

In an embodiment, the optical waveguide may include or be an optical fiber.

According to an aspect of the present disclosure, a method of inductively heating of an object is presented. The method may include positioning an inductive heating coil in a proximity of the object. The method may further include providing electrical power to the inductive heating head by means of an electronic controller. The method may further include positioning at least one optical waveguide in between the inductive heating coil and the object, wherein each optical waveguide may include at least one optical temperature sensor. The method may further include obtaining measurement signals in the at least one optical temperature sensor by means of light. The method may further include receiving, by an optical measurement subsystem, the measurement signals from the at least one optical temperature sensor of each of the at least one optical waveguide. The method may further include determining, by the optical measurement subsystem, a at least one local temperature in the object based on the measurement signals. The method may further include providing a feedback signal, by the optical measurement subsystem, to the electronic controller, wherein the feedback signal is based on the at least one local temperature.

Advantageously, this method allows for achieving higher accuracy compared to known inductive heating systems. As mentioned before, the optical waveguide includes a piece of material that is not heated by induction, because it is not electrically conductive. Since it is not heated by the induction coil, it can measure true temperatures of the object. These measurements are obtained optically with the use of light and the obtained temperature reading may subsequently be utilized to provide feedback to the electronic controller of the system to adjust induction parameters. These, in turn, may adjust the temperature of the object.

The method thus enables fine-tuning of the induction parameters based on true temperature readings of the object, wherein the object's temperature may be controlled by changing the amplitude of the electrical power (e.g., height of the control signal), the duration of inductive heating, location of the object relative to the heating coil, and/or the like. In that regard, induction parameters may include heating in a different amount of time in which electrical power is provided, having a different position relative to the inductive heating coil, and/or having a differently heating coil or object. Furthermore, electrical power may be defined by the electrical current, properties of the heating coil, and/or the electrical voltage.

It should be noted that the steps of positioning positioning the inductive heating coil in a proximity of the object and the step of positioning at least one optical waveguide in between the inductive heating coil and the object, may be performed at the same time, wherein the relative distance between the inductive heating coil and the at least one optical waveguide is predetermined, such that the combination of the heating coil and the at least one optical waveguide can be positioned adjacent to the object.

In an embodiment the method may further include adjusting, by the electronic controller, the provided electrical power to the inductive heating coil based on the feedback signal.

Advantageously, adjusting the electrical power provided to the inductive heating coil by the electronic controller may immediately affect the amount of energy transfer/absorption to the object, thereby directly affecting its temperature. For example, the temporal peak or total amount of energy provided to the object may be adjusted, and/or the timespan over which the electrical power is provided may be adjusted. Adjustments by the electronic controller may be based on the feedback signal to decrease the provided electrical power, in an example at a slow rate because the object itself may be losing a lot of energy due to radiation. A drop in provided electrical power would then decrease the temperature of the object in a greater amount then a drop in provided electrical power of equal amount of an object which is losing/radiating less energy.

In an embodiment, the method may further include instructing, by the electronic controller, moving means configured to move the inductive heating coil to adjust the position of the inductive heating head relative to the object to be heated based on the feedback signal.

In an embodiment, the method may further include instructing, by the electronic controller, moving means configured to change the relative distance between the object and the heating coil by either moving the object or by moving the heating coil.

The inductive power transfer from the heating coil to the object may be adjusted by changing the relative distance between the two. For example, when the distance between the heating coil and the object is increased, less power is transferred between the two, resulting in a lower temperature of the object.

The heating coil typically has a three-dimensional shape. Repositioning of the object relative to the heating coil may increase the distance on one side while decreasing the distance on the other side. Advantageously, the heat distribution may be changed on/in the object. The at least two local temperatures of the object may be individually tuned by changing the relative position of the object and the heating coil.

In an embodiment, the method may include the feedback signal being determined based on mathematical operations on the at least one local temperature. The mathematical operations may include one or more of: an arithmetic mean; a minimum; a maximum; a weighted average.

The feedback signal may be based on the at least one local temperature. In particular, when the at least one local temperature includes a plurality of local temperatures, mathematical operations may be used to have the electronic controller provide the correct electrical power to the heating coil. For example, the electronic controller may calculate the arithmetic mean to determine the average temperature of the object. For example, in case the optical temperature sensors are provided on different sides of the object, the arithmetic mean may provide information of the approximate temperature at the midpoint of the object.

In an embodiment, the method may include comparing, by the optical measurement subsystem, the at least one local temperature to a spatial model of the object to determine the feedback signal.

A spatial or three-dimensional temperature model of the object may be utilized to obtain specific local temperature information of the object of locations that are not directly measured by the optical temperature sensors. For example, the centre core of the object may not be directly measured by the optical temperature sensors, however, the surface temperature in combination with information from a three-dimensional or spatial model may give good insight into the interrelatedness between the measured and the desired location's temperature.

In an embodiment, in the step of providing electrical power, the electrical power may be adjusted based on the feedback signal until the determined at least one local temperature has reached a predefined temperature value.

In it can be beneficial to have a predefined temperature value set in the electronic controller to which the object is desired to be heated.

In an embodiment, the step of providing electrical power may be stopped based on the feedback signal when the determined at least one local temperature has reached a predefined critical temperature value.

The predefined critical temperature may be different from the predefined temperature and may be utilized to safeguard the heating process. For example, in some applications it may be possible that the object needs to be heated to a specific temperature for, e.g., heat treatment, soldering or welding, which temperature is close to a temperature that causes the object to deform, melt, or disintegrate. The predefined critical temperature value may be used to ensure that the object is not heated past said critical temperature by stopping providing of electrical power.

Controlling based on a predefined critical temperature may be combined with other control loop methods as described above to cope with, e.g., overshoots in the feedback signal and consequently to overshoots in the temperature of the object.

In an embodiment, the method may further include an initialization step, wherein an initial electrical power and/or an initial position of the induction coil relative to the object are determined.

The initialization step may be performed experimentally or by simulation to obtain rough heating process parameters. The thus obtained rough heating process parameters may be used by the control loop/feedback system to finetune the supplying of electrical power and subsequent heating of the object. Such initialization step can be beneficial to allow for repetition of an inductive heating process of alike objects. For example, the joinder of two pieces of pipe by means of solder may be performed as an automated production process using the method of the present disclosure. Since the pieces of pipe are typically similar, the rough parameters may give a good starting point for the inductive heating process. However, since there may exist small discrepancies between pieces of pipe in pipe material, thickness, position, and etcetera, subsequent heating processes may not be exactly the same. Advantageously, the solutions of the present disclosure utilize the feedback signal obtained from determined local temperature(s) to get process specific information and give process specific feedback.

It would thus be understood by the expert in the field that from object to object even in a production line the impedance differences would dominate the differences between the required heating parameters. For instance, each object has margins in its thickness, mass, quality of the alloy/metal and/or pre-heat treatments. All these factors would influence the electro-magnetic inductive fields. The benefit of the current method according to the disclosure allows for mitigating all these differences, because the true temperature of the to-be-heated object is measured and used as feedback.

In an embodiment, the feedback signal may be used to adjust at least one heating process parameter. The at least one heating process parameters parameter may include one or more of: heating time; electrical power; electrical power rate; position of the heating coil relative to the object; movement speed of the heating coil; and movement speed of the object.

Throughout the disclosure a feedback signal is discussed. In a preferred example this feedback signal is based on the difference between the at least one local temperature and an intended temperature for the object to reach. Furthermore, by means of the feedback signal a so-called “closed loop” heating system is obtained.

The system and the method of the present disclosure are based on an optical measurement subsystem. The optical measurement subsystem typically includes at least one optical waveguide and is typically configured to emit, for each waveguide, a first optical electromagnetic wave. The optical measurement subsystem may be configured to detect a second optical electromagnetic wave reflected by the at least one optical temperature sensor of the respective waveguide, wherein the second electromagnetic wave may be indicative of the temperature of the object to be heated.

In an embodiment, spectral information of a first optical electromagnetic wave may be compared to a second optical electromagnetic wave, for example, a peak position as a measure of the temperature of the at least one optically reflective temperature sensor. This spectral information may be adaptively calibrated in the system. Alternatively, such calibration may be performed during the manufacturing process of the optical waveguide, said information possibly being provided to the user of the system or being preconfigured in the system.

The solutions of the present disclosure enable higher accuracy in inductive heating compared to known inductive heating systems, because the optical waveguide is not affected (heated-up), allowing for true temperature measurements of the object. These temperature measurements may be utilized as feedback to fine tune the object's temperature (height, duration, location). Furthermore, the actual temperature measurement results in a better representation of the true situation compared to the feedback signal of known systems, thus allowing the system and the method of the present disclosure to operate with higher accuracy and lower tolerances.

### BRIEF DESCRIPTION OF THE DRAWINGS

Embodiments of the present disclosure will now be described, by way of example only, with reference to the accompanying schematic drawings in which corresponding reference symbol indicate corresponding parts, in which:

FIG. 1 shows a schematic drawing of an exemplary inductive heating system;

FIG. 2 shows an example of an inductive heating coil with an optical waveguide in between the object and the coil;

FIG. 3 shows a cross-section of an optical waveguide comprising a reflective optical sensor;

FIG. 4 shows a block diagram of steps of a method of the present disclosure; and

FIGS. 5A-5D show various temperature graphs of methods according to the present disclosure.

The figures are intended for illustrative purposes only, and do not serve as restriction of the scope of the protection as laid down by the claims.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the present disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single example of the present disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same example.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure. Reference throughout this specification to “one embodiment,” “an embodiment,” or similar language means that a particular feature, structure, or characteristic described in connection with the indicated embodiment is included in at least one embodiment of the present disclosure. Thus, the phrases “in one embodiment,” “in an embodiment,” and similar language throughout this specification may, but do not necessarily, all refer to the same embodiment.

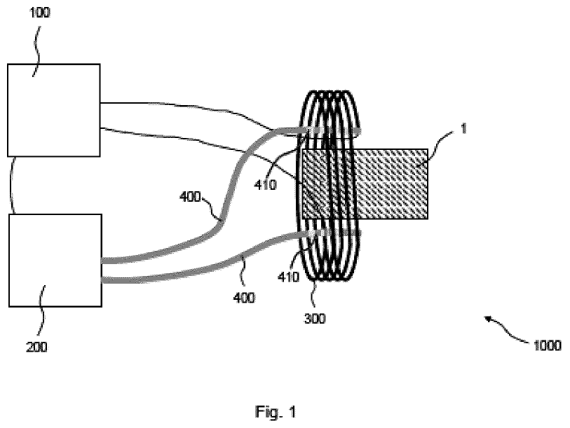

In FIG. 1, a schematic representation of an example system 1000 for inductively heating an object 1 is shown. This system 1000 comprises an inductive heating coil 300, which is coupled to an electronic controller 100 adapted to provide electrical power to the inductive heating coil 300. The inductive heating coil is positioning in the proximity of the object 1, which is intended to be heated inductively. The relative distance between the inductive heating coil 300 and the object 1 determines the amount of inductive power that is being transferred, which in turn heats the object 1.

Furthermore, FIG. 1 shows two optical waveguides 400 positioned in between the inductive heating coil 300 and the object 1. Each optical waveguide 400 comprises at least one optical temperature sensor 410, wherein the at least one optical temperature sensor 410 is arranged to obtain measurement signals by means of light.

To do so, an optical measurement subsystem 200 is optically connected to the two optical waveguides 400 and is adapted to receive the measurement signals from the at least one optical temperature sensor 410 of the at least one optical waveguide 400. Hereto, the optical measurement subsystem 200 may emit a light pulse with certain spectral characteristics and measure the reflected light pulse.

From this measurement signal, at least one local temperature of the object 1 is determined by the optical measurement subsystem 200 based on the measurement signals. Subsequently, the optical measurement subsystem 200 provides a feedback signal to the electronic controller 100 based on the plurality of determined local temperatures.

Based on said feedback signal, the electronic controller 100 adjusts the provided electrical power to the inductive heating coil 300, thereby obtaining a closed-loop inductive heating system 1000.

A benefit of the inductive heating system of the present disclosure, such as the example inductive heating system 1000 of FIG. 1, is that higher accuracy can be obtained compared to known inductive heating systems. Namely, with reference to the example of FIG. 1, the optical waveguides 400, which preferably are optical fibres, are not heated by induction, because they are not electrically conductive. This ensures that the temperature measurement measured by the optical waveguides 400 are true temperature measurements of the object 1, instead of convoluted measurements due to sensor heating. Furthermore, the optical waveguides 400 allow for determining the temperature of the object 1 in close proximity, whereas known systems rely on distant measurements.

These true temperature measurements are subsequently used to provide feedback to the system 1000, such that the induction parameters can be tuned finely based on the requirements of the object's temperature (value, duration, location).

The system 1000 may further comprise moving means (not shown in FIG. 1) to change the relative distance between the inductive heating coil 300 and the object 1. It is thus noted that the feedback signal may not only be used to adjust the electrical power provided to the inductive heating coil 300, but that the relative distance may also be adjusted as means to adjust the transfer of inductive power to the object 1.

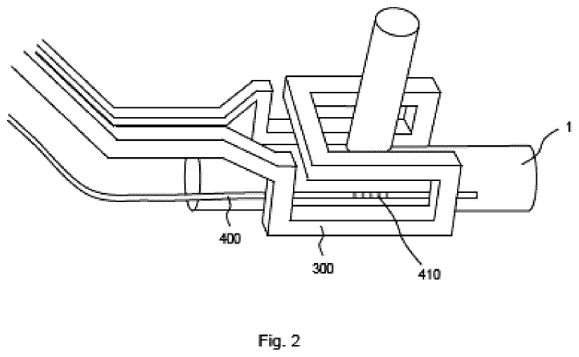

In FIG. 2, an example of an inductive heating coil 300 is shown in close-up. The inductive heating coil 300 is shown to surround the object 1 to be inductively heated. In the example of FIG. 2, the object 1 comprises two tubes, in this example two perpendicularly oriented tubes, which are intended to be soldered or welded together.

In the example of FIG. 2, one optical waveguide 400 comprises an optically reflective sensor 410 in between the inductive heating coil 300 and the object 1. The local temperature determination may be performed at the optically reflective sensor 410, and its position in relation to the object is thus of importance, especially when spatial temperature models or mathematical operations are used to obtain temperature information of a specific location of the object 1.

The position of the inductive heating coil 300 relative to the object 1 may be important, not only in terms of inductive power that is being transferred, but also in relation to the geometry of the object 1. The inductive heating coil's 300 inside compared to the object's 1 outside may cause inductive power transfer to be different from one side of the object 1 compared to the other side of the object 1 in case there exists a misalignment.

To circumvent the occurrence of such misalignments, it may be beneficial to use two optical waveguides 400, on both sides of the object 1, such that insight can be gained on the temperature differences between both sides. Positioning errors may cause the object 1 to be hotter on one side compared to the other. The system 1000 may then decide to shut off the electrical power supply to the inductive heating coil 300 or alternatively, with the use of moving means, re-adjust the relative positioning between the inductive heating coil 300 and the object 1.

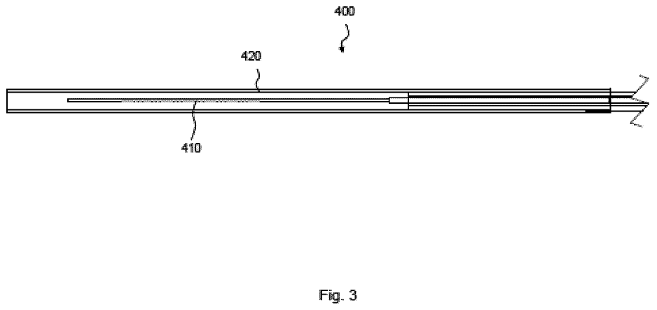

An example embodiment of a section of an optical waveguide, such as the optical waveguide(s) 400 of FIGS. 1 and 2, is shown in FIG. 3. The optical waveguide 400 may include one or more optical fibres comprising a core, a cladding, and a protective jacket. To protect the optical temperature sensor 410 of the optical waveguide, an additional protective encasing 420 is optionally provided, e.g., at the fibre tip end, substantially encasing the optical temperature sensor 410.

Examples of optical temperature sensors 410 are FBGs, FPEs, DBRs, Photonic Bandgap Structures, Photonic Crystals, Reflective Coatings and Grating Structures.

Such optical temperature sensors are intrinsically all structures that provide an alternating refractive index, thereby causing light travelling in the optical waveguide 400 to (at least partially) reflect. Furthermore, these alternating refractive index portions of the optical waveguide 400 may expand or shrink due to an increase or a decrease in temperature, respectively. This causes the spectral characteristics of the reflected light pulse to be different, wherein the spectral characteristics may be understood as center wavelength, spectral width, spectral height, and etcetera. Upon measurement of said reflection pulse, the optical measurement subsystem 200 may relate a temperature to a specific measured spectral characteristic. The temperature resolution that can be achieved with the system 1000 can be very precise, e.g., in the order of 0.1 degrees Celsius.

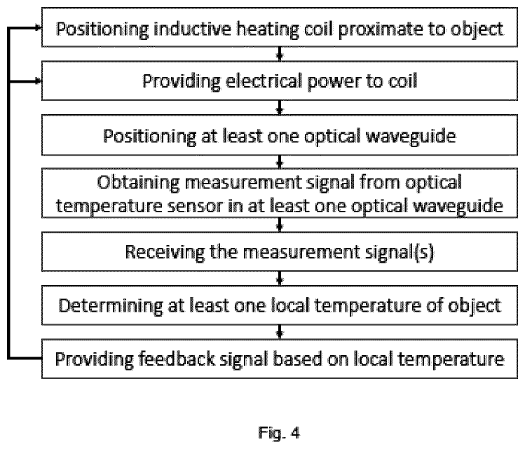

FIG. 4 shows a block diagram of steps of an example method of the present disclosure. The method may include positioning an inductive heating coil 300 in a proximity of the object 1. The method may further include providing electrical power to the inductive heating head 300 by means of an electronic controller 100. The method may further include positioning at least one optical waveguide 400 in between the inductive heating coil 300 and the object 1, wherein each optical waveguide 400 comprises at least one optical temperature sensor 410. The method may further include obtaining measurement signals in the at least one optical temperature sensor 410 by means of light. The method may further include receiving, by an optical measurement subsystem 200, the measurement signals from the at least one optical temperature sensor 410 of each of the at least one optical waveguide 400. The method may further include determining, by the optical measurement subsystem 200, a at least one local temperature in the object based on the measurement signals. The method may further include providing a feedback signal, by the optical measurement subsystem 200, to the electronic controller 100, wherein the feedback signal is based on the at least one local temperature.

The steps of the method may be performed in another order than presented in FIG. 4. For example, the step of positioning at least one optical waveguide 400 may be performed combined with positioning the inductive heating coil 300, such that both steps are performed before providing electrical power to the conductive heating coil 300.

The feedback signal that is obtained by the method of the present disclosure, such as the method of FIG. 4, may be utilized to adjust, by the electronic controller 100, the provided electrical power or position of the inductive heating coil 300. That way, a closed loop may be realized, wherein the steps of the method may be repeated, e.g., continuously.

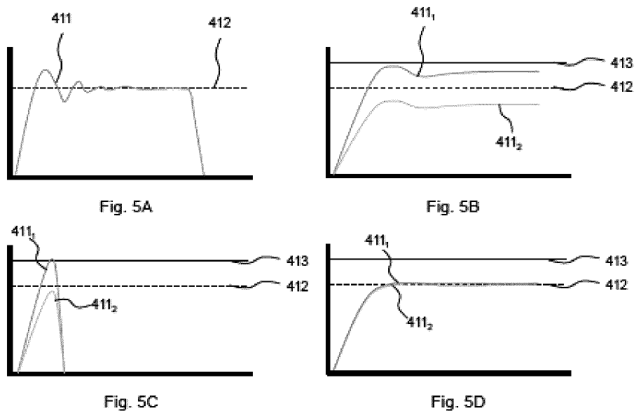

With reference to FIGS. 5A-5D, in order to break such continuous loop, stop or break points may be implemented, wherein the determined local temperature of the object 1 may be compared to a predefined temperature value 411 or a predefined critical temperature value 412. When such temperature value 411, 412 is reached temporarily or for a defined amount of time, this may cause the electronic controller 100 to stop providing electrical power or alternatively set the feedback signal to zero.

In FIGS. 5A-5D time-temperature graphs of different example cases are shown.

In FIG. 5A, a temperature trace of a system, such as system 1000, with one optical temperature sensor 400 is shown. The determined temperature 411 of the object 1 is shown as a function of time as well as the predefined temperature value 412 for the object 1 to reach. It can be seen that the determined temperature 411 in the beginning is low and ramps up rapidly due to the provided electrical power to the inductive heating coil 300, subsequently heating the object 1. Once the temperature comes close to the predefined temperature value 412, the feedback signal is reduced, but lag in the system 1000 causes the determined temperature 411 to overshoot. The amount of provided electrical power is then reduced, such that the determined temperature 411 falls below the predefined temperature 412, possibly causing an undershoot. These overshoots and undershoots are shown to occur a few times, but with a dampening effect, such that a steady determined temperature 411 at the predefined temperature value 412 is obtained. Subsequently, after a predefined amount of time (at the correct temperature) has passed, the electronic controller 100 may shut off the feedback loop and the object 1 cools back down to its starting temperature.

In FIG. 5B, determined temperatures 411₁ and 411₂ are shown of a system 1000 comprises two optical temperature sensors 410. Again, a rise from a start time point with overshoots and undershoots is shown. Moreover, the first determined temperature 411₁ continuously lies above the predefined temperature 412 and second determined temperature 411₂ continuously lies below the predefined temperature. Yet, the arithmetic mean of both the first and second determined temperature (411₁/411₂) asymptotes towards the predefined temperature value 412. Furthermore, a predefined critical temperature is shown with the dotted line 413, which is not surpassed by either temperature curve.

In FIG. 5C, however, this predefined critical temperature is surpassed by the first determined temperature 411₁, causing the electronic controller 100 to shut down the feedback control and to shut down providing electrical power to the inductive heating coil 300, such that the temperature immediately drops back to the initial starting temperature.

In FIG. 5D, two temperatures curves (411₁/411₂) are shown, which have minimal overshoots and undershoots. They nicely asymptote to the predefined temperature value 412. This effect is depended on the exact settings of the control-loop and differ between different heating cases.

It should be noted that in FIG. 5D both determined temperatures seem to be of the approximate same temperature at any given time. In case the two temperature sensors are provided on opposite sides of the object 1, the temperature curves of FIG. 5D would also indicate that the relative position of the object 1 to the inductive heating coil 300 is optimal, such that both sides of the object 1 are heated approximately the same. On the other hand, the two curves (411₁/411₂) of FIG. 5B would indicate that the object 1 and the inductive heating coil 300 are misplaced with respect to each other, such that one side of the object 1 becomes hotter than the other side.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1. A system for inductive heating of an object, the system comprising:
an inductive heating coil;
an electronic controller adapted to provide electrical power to the inductive heating coil, at least one optical waveguide positioned adjacent to the inductive heating coil and the object, wherein each optical waveguide comprises at least one optical temperature sensor, wherein the at least one optical temperature sensor is arranged to obtain measurement signals by means of light; and
an optical measurement subsystem, wherein the optical measurement subsystem is adapted to receive the measurement signals from the at least one optical temperature sensor of the at least one optical waveguide, wherein the optical measurement subsystem is further adapted to determine at least one local temperature of the object based on the measurement signals, and wherein the optical measurement subsystem is adapted to provide a feedback signal to the electronic controller based on the plurality of local temperatures.

2. The system according to claim 1, wherein the electronic controller is adapted to adjust the provided electrical power to the inductive heating coil based on the feedback signal.

3. The system according to claim 1, further comprising:
moving means configured to move the inductive heating coil,
wherein the moving means are adapted to adjust the position of the inductive heating coil relative to the object to be heated based on the feedback signal.

4. The system according to claim 1, wherein the optical measurement subsystem is adapted to use the feedback signal as one of:
proportionally (P control loop);
both proportionally and integratively (PI control loop);
both proportionally and derivatively (PD control loop);
both proportionally integratively and derivatively (PID control loop); and
by second order.

5. The system according to claim 1, wherein the at least one optical waveguide comprises at least two optical temperature sensors to determine the at least two local temperatures of the object.

6. The system according to claim 1, wherein the at least one optical waveguide comprises at least two optical waveguides to determine the least two local temperatures of the object.

7. The system according to claim 5, wherein the optical measurement subsystem is arranged to determine the at least two local temperatures based on mathematical operations to determine the feedback signal, wherein the mathematical operations include one or more of: an arithmetic mean; a minimum; a maximum; a weighted average.

8. The system according to claim 1, wherein the optical measurement subsystem is arranged to compare the plurality of local temperatures to a spatial model of the object to determine the feedback signal.

9. The system according to claim 1, wherein the at least one optical temperature sensor comprises one or more of:
a Fiber Bragg Grating, FBG;
a Fabry-Pérot etalon, FPE;
a Distributed Bragg Reflector, DBR;
a Photonic Bandgap Structure;
a Photonic Crystal;
Reflective Coating; and
a Grating Structure.

10. The system according to claim 1, wherein the optical waveguide comprises an optical fiber.

11. A method of inductively heating of an object, the method comprising:
positioning an inductive heating coil in a proximity of the object;
providing electrical power to the inductive heating head by means of an electronic controller;
positioning at least one optical waveguide adjacent to the inductive heating coil and the object, wherein each optical waveguide comprises at least one optical temperature sensor;
obtaining measurement signals in the at least one optical temperature sensor by means of light;
receiving, by an optical measurement subsystem, the measurement signals from the at least one optical temperature sensor of each of the at least one optical waveguide,
determining, by the optical measurement subsystem, at least one local temperature in the object based on the measurement signals; and
providing a feedback signal, by the optical measurement subsystem, to the electronic controller, wherein the feedback signal is based on the at least one local temperature.

12. The method according to claim 11, further comprising adjusting, by the electronic controller, the provided electrical power to the inductive heating coil based on the feedback signal.

13. The method according to claim 11, further comprising instructing, by the electronic controller, moving means configured to move the inductive heating coil to adjust the position of the inductive heating head relative to the object to be heated based on the feedback signal.

14. The method according to claim 11, wherein the feedback signal is determined based on mathematical operations on the at least one local temperature, wherein the mathematical operations include one or more of: an arithmetic mean; a minimum; a maximum; a weighted average.

15. The method according to claim 1, comprising comparing, by the optical measurement subsystem, the at least one local temperature to a spatial model of the object to determine the feedback signal.

16. The method according to claim 11, wherein in the step of providing electrical power, the electrical power is adjusted based on the feedback signal until the determined at least one local temperature has reached a predefined temperature value.

17. The method according to claim 11, wherein in the step of providing electrical power is stopped based on the feedback signal when the determined at least one local temperature has reached a predefined critical temperature value.

18. The method according to claim 11, further comprising an initialization step, wherein an initial electrical power and/or an initial position of the induction coil relative to the object are determined.

19. The method according to claim 11, wherein the feedback signal is used to adjust at least one heating process parameter, the at least one heating process parameter comprising one or more of:
heating time;
electrical power;
electrical power rate;
position of the heating coil relative to the object;
movement speed of the heating coil; and
movement speed of the object.
